(19) United States
(12) Patent Application Publication
(10) Pub. No.: US 2001/0049419 A1
(43) Pub. Date: Dec. 6, 2001

(54) Novel polymer, preparation process, use as thickener and/or emulsifier and composition comprising it

(76) Inventors: Paul Mallo, Chatou (FR); Bernard Brancq, Le Chesnay (FR); Guy Tabacchi, Castres (FR); Jean-Pierre Boiteux, Saix (FR)

Correspondence Address: YOUNG & THOMPSON, 745 SOUTH 23RD STREET 2ND FLOOR, ARLINGTON, VA, 22202

(21) Appl. No.: 09/819,795

(22) Filed: Mar. 29, 2001

(30) Foreign Application Priority Data
Mar. 29, 2000 (FR) 000 3955

(51) Int. Cl. C08F 228/00

(52) U.S. Cl. 525/328.5; 525/329.7; 525/329.9

(57) ABSTRACT

Linear, branched or crosslinked polymer based on at least one monomer, possessing a free, partially salified or completely salified strong acid functional group, copolymerized with at least one monomer chosen either from esters of aliphatic alcohols comprising from 8 to 30 carbon atoms and of unsaturated monocarboxylic acids or from esters of aliphatic alcohols comprising from 8 to 30 carbon atoms and of unsaturated polycarboxylic acids. Preparation process, use as thickener and/or emulsifier and composition comprising it.

The present application relates to novel thickening and/or emulsifying polymers.

Various emulsifying copolymers composed of a major fraction of an unsaturated carboxylic acid monomer comprising from 3 to 6 carbon atoms or of its anhydride and of a minor fraction of an acrylic acid fatty ester monomer are sold under the name of Pemulen™. They are disclosed in U.S. Pat. Nos. 5,373,044 and 5,288,814. However, these polymers have to be neutralized to become emulsifying and they thus do not work in an acid medium.

Poly(alkali metal 2-acrylamido-2-methylpropane-sulphonate)s are disclosed in the European patent application published under the number 0 814 403. However, such polymers do not exhibit emulsifying properties. The Applicant Company has therefore been interested in the synthesis and in the development of thickening and emulsifying polymers in the solid form which are ready for use, that is to say which do not require neutralization, which can be easily dispersed in water and which can be used over a wide pH range.

A subject-matter of the invention is a linear, branched or crosslinked polymer based on at least one monomer, possessing a free, partially salified or completely salified strong acid functional group, copolymerized with at least one monomer chosen either from esters of aliphatic alcohols comprising from 8 to 30 carbon atoms and of unsaturated monocarboxylic acids or from esters of aliphatic alcohols comprising from 8 to 30 carbon atoms and of unsaturated polycarboxylic acids.

The term “branched polymer” denotes a nonlinear polymer which has pendant chains, so as to obtain, when this polymer is dissolved in water, a high state of entanglement, leading to very high viscosities at a low gradient.

The term “crosslinked polymer” denotes a nonlinear polymer which exists in the state of a three-dimensional network which is insoluble in water but swellable in water and which thus results in a chemical gel being obtained.

The composition according to the invention can comprise crosslinked units and/or branched units.

The crosslinking agent and/or the branching agent is chosen from polyethylenic monomers, such as, for example, diallyloxyacetic acid, CH(O—CH₂—CH═CH₂)₂—C(═O)—OH or one of the salts and in particular its sodium salt, trimethylolpropane triacrylate CH₃—C[CH₂—O—C(═O)—CH═CH₂]₃, ethylene glycol dimethacrylate CH₂═C (CH₃)—C (═O)—O—(CH₂)₂—O—C (═O)—C(CH₃)═C 2, diethylene glycol diacrylate CH₂═CH—C(═O)—O—[(CH₂)₂—O]₂—C (═O)—CH═CH₂, tetraethylene glycol diacrylate CH₂═CH—C(═O)—O—[(CH₂)₂—O]₄—C(═O)—CH═CH₂, methylenebis(acrylamide) CH₂═CH—C(═)—NH—CH₂—NH—C(═O)—CH═CH₂, diallylurea CH₂═CH—CH₂—NH—C(═O)—NH—CH₂—CH═CH₂, triallylamine N(—CH₂—CH═CH₂)₃ or 1,1,2,2-tetraallyloxy-ethane (tetraallyloxyethane) CH(O—CH₂—CH═CH₂) ₂—CH (O—CH₂—CH═CH₂)₂.

The term “partially or completely salified” means that the strong acid functional groups are partially or completely salified in the form in particular of an alkali metal salt, such as the sodium salt or the potassium salt, of the ammonium salt (NH₄⁺) or of an aminoalcohol salt, such as, for example, the monoethanolamine salt (HOCH₂CH₂NH₃⁺).

The strong acid functional group of the monomer comprising it is in particular the sulphonic acid functional group or the phosphonic acid functional group. The said monomer can be, for example, styrenesulphonic acid, (2-sulphoethyl) methacrylate, styrenephosphonic acid or, preferably, 2-methyl-2-[(1-oxo-2-propenyl)amino]-1-propanesulphonic acid, CH₃—C(CH₃)[NH—C(═O)—CH═CH₂]—CH₂—SO₃H, the said acids being free, partially salified or completely salified.

The term “esters of unsaturated polycarboxylic acids” denotes the monoesters or polyesters of the said acids. Thus, when it is a diacid, the definition includes the monoester and the diester. The unsaturated carboxylic acid is more particularly chosen from α-unsaturated acids, such as α-unsaturated monocarboxylic acids or α-unsaturated dicarboxylic acids, such as, for example, acrylic acid CH₂═CH—C(═O)—OH, methacrylic acid CH₂═C(CH₃)—C(═O)—OH, itaconic acid CH₂[C(═O)—OH]—C(═CH₂)—C(═O)—OH, or maleic acid CH[C(═O)—OH]═CH—C(═O)—OH.

The term “aliphatic radical comprising from 8 to 30 carbon atoms” more particularly denotes a saturated or unsaturated and linear or branched radical.

The term “saturated or unsaturated, linear hydrocarbonaceous aliphatic radical comprising from 8 to 30 carbon atoms” more particularly denotes radicals derived from linear primary alcohols, such as, for example, those derived from octyl, pelargonyl, decyl, undecyl, undecenyl, lauryl, tridecyl, myristyl, pentadecvl, cetyl, heptadecyl, stearyl, oleyl, linoleyl, nonadecyl, arachidyl, behenyl, erucyl or 1-triacontyl alcohols. They are then the octyl, nonyl, decyl, undecyl, 10-undecenyl, dodecyl, tridecyl, tetradecvl, pentadecyl, hexadecyl, heptadecyl, octadecyl, 9-octadecenyl, 10,12-octadecadienyl, nonadecyl, 13-docosenyl, docosyl or triacontyl radicals.

The term “branched unsaturated hydrocarbonaceous radical comprising from 8 to 30 carbon atoms” more particularly denotes either radicals derived from Guerbet alcohols, which are branched 1-alkanols corresponding to the general formula:

CH₃—(CH₂)ₚ—CH[CH₃—(CH₂)ₚ₋₂]—CH₂OH,

in which p represents an integer between 2 and 14, such as, for example, the 2-ethylhexyl, 2-propylheptyl, 2-butyloctyl, 2-pentylnonyl, 2-hexyldecyl or 2-octyl-dodecyl radicals, or radicals derived from isoalkanols corresponding to the general formula:

CH₃—CH(CH₃)—(CH₂)ₘ—CH₂OH,

in which m represents an integer between 2 and 26, such as, for example, the 4-methylpentyl, 5-methylhexyl, 6-methylheptyl, 15-methylpentadecyl or 16-methylhepta-decyl radicals, or the 2-hexyloctyl, 2-octyldecyl or 2-hexyldodecyl radicals.

Another subject-matter of the invention is a polymer as defined above, characterized in that 30% to 98% of the monomer units which it comprises have a free, partially salified or completely salified strong acid functional group.

The polymer as defined above more particularly comprises from 30% to 98% by weight of at least one monomer having a strong acid functional group, from 1% to 15% by weight of at least one ester with a fatty chain of-an unsaturated carboxylic acid, from 0.01% to 5% by weight of at least one polyethylenic monomer and from 0% to 60% by weight of at least one monomer which does not belong to the families defined above, such as, for example, a neutral monomer or a monomer with a free, partially salified or completely salified, nonesterified carboxylic acid functional group.

As neutral monomer, there is, for example, acrylamide CH₂═CH—C(═O)—NH, methacrylamide CH₂═C(CH₃)—C(═O)—NH, vinylpyrrolidone

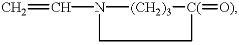

(2-hydroxyethyl) acrylate CH₂═CH—C(═O)—O—CH₂—CH₂—OH, (2-hydroxyethyl) methacrylate CH₂═C(CH₃)—C(═O)—O—CH₂—CH₂—OH, (2,3-dihydroxypropyl) acrylate CH₂═CH—C(═O)—O—CH₂—CH (OH)—CH₂—OH, (2,3-dihydroxypropyl) methacrylate CH₂═C(CH₃)—C(═O)—O—CH₂—CH(OH)—CH₂—OH or an ethoxylated derivative with a molecular weight of between 400 and 1000 of each of the hydroxylated esters described above.

As monomer with a nonesterified carboxylic acid functional group, there is, for example, acrylic acid, methacrylic acid, itaconic acid or maleic acid. When these acids are partially or completely salified, they are more particularly an alkali metal salt, such as the sodium salt or potassium salt, the ammonium salt (NH₄⁺) or an aminoalcohol salt, such as, for example, the monoethanolamine salt (HOCH₂CH₂NH₃⁺).

According to another aspect of the present invention, a subject-matter of the latter is a process for the preparation of the polymer as defined above, characterized in that:

a) all the monomers are dissolved in a solvent,

b) the polymerization reaction is initiated by the introduction, into the solution formed in a), of a free radical initiator and then the reaction is allowed to take place,

c) when the polymerization reaction is finished, the residue obtained is filtered off and dried to obtain the said polymer in the solid form.

The solvent in which the dissolution of the monomers is carried out is chosen, for example, from cyclohexane, ethyl acetate or tert-butanol. The polymerization reaction is initiated using a peroxide or azo initiator, such as, for example, dilauryl peroxide, azobis(isobutyronitrile) (AIBN) or bis(2-ethylhexyl) peroxydicarbonate. The polymerization reaction is carried out between 35 and 85° C., more particularly between 50 and 70° C., at atmospheric pressure and for approximately 2 hours.

Another subject-matter of the invention is the use of the polymer as defined above for preparing a cosmetic, dermocosmetic, dermopharmaceutical or pharmaceutical topical composition.

A topical composition according to the invention, intended to be applied to the skin or mucous membranes of man or animals, can be composed of a topical emulsion comprising at least one aqueous phase and at least one oily phase. This topical emulsion can be of the oil-in-water type. More particularly, this topical emulsion can be composed of a fluid emulsion, such as a milk or a fluid gel. The oily phase of the topical emulsion can be composed of a mixture of one or more oils.

A topical composition according to the invention may be intended for a cosmetic use or be used for preparing a medicament intended for the treatment of diseases of the skin and mucous membranes. The topical composition optionally comprises an active principle which can, for example, be an anti-inflammatory agent, a muscle relaxant, an antifungal or an antibacterial.

When the topical composition is used as a cosmetic composition intended to be applied to the skin or mucous membranes, it may or may not comprise an active principle, for example a moisturizing agent, a tanning agent, a sunscreen agent, an agent for combating wrinkles, an agent with a slimming purpose, an agent for combating free radicals, an antiacne agent or an antifungal agent.

A topical composition according to the invention usually comprises between 0.1% and 10% by weight of the thickening agent defined above. The pH of the topical composition is preferably greater than or equal to 5.

The topical composition can additionally comprise compounds conventionally included in compositions of this type, for example fragrances, preservatives, dyes, emollients or surfactants.

According to yet another aspect, the invention relates to the use of the novel thickening agent in accordance with the abovementioned invention for thickening and/or emulsifying inks, paints or compositions for dyeing natural or synthetic textile fibres, or dyeing or pigmentary compositions for woven or nonwoven products.

The following examples illustrate the present invention without, however, limiting it.

### EXAMPLE 1

AMPS/MA C₁₈ Ester (97/3) Copolymer Cross-linked with TAOE

The following materials:

1000 g of tert-butanol,

6.75 g of commercial octadecyl methacrylate (MA C₁₈ ester),

150 g of commercial 2-methyl-2-[(1-oxo-2-propenyl)amino]-1-propanesulphonic acid (AMPS™),

12.3 g of ammonia,

4 g of tetraallyloxyethane (TAOE), are successively charged to a reactor with stirring.

The mixture is subjected to sparging with nitrogen for approximately 1 hour at ambient temperature and then it is brought to 70° C., at which temperature 0.3 g of bis(2-ethylhexyl) peroxy-dicarbonate is introduced therein. It is subsequently maintained for approximately 2 hours at this temperature and then it is left at reflux for 2 hours. After filtration and drying under reduced pressure at 60° C. for 8 hours, the AMPS/MA C₁₈ ester copolymer, crosslinked with tetraallyloxyethane, is obtained, in which copolymer the molar ratio of AMPS/MA C₁₈ ester monomers is equal to 97/3.

### EXAMPLE 2

AMPS/MA C₁₈ Ester (94/6) Copolymer Cross-linked with TAOE

The compound is obtained by carrying out the preparation in the same way as in Example 1 but using 13 g of octadecyl methacrylate and 146 g of 2-methyl-2-[(1-oxo-2-propenyl)amino]-1-propanesulphonic acid, in order for the molar ratio of AMPS/MA C₁₈ ester monomers to be equal to 94/6.

### EXAMPLE 3

AMPS/MA C₁₈ Ester (97/3) Copolymer Cross-linked with TMPTA

The compound is obtained by carrying out the preparation in the same way as in Example 1 but using 4 g of trimethylolpropane triacrylate (TMPTA) instead of tetraallyloxyethane.

### EXAMPLE 4

AMPS/MA C₁₈ Ester (88/12) Copolymer Cross-linked with-TAOE

The following materials:

1000 g of tert-butanol,

26 g of octadecyl methacrylate,

136.8 g of commercial 2-methyl-2-[(1-oxo-2-propenyl)amino]-1-propanesulphonic acid (AMPSTM),

11 g of ammonia,

3 g of tetraallyloxyethane (TAOE), are successively charged to a reactor with stirring.

The mixture is subjected to sparging with nitrogen for approximately 1 hour at ambient temperature and then it is brought to 70° C., at which temperature 4 g of azobis(isobutyronitrile) are introduced therein. It is subsequently maintained at this temperature for approximately 2 hours and then it is left at reflux for two hours. After filtration and drying under reduced pressure at 70° C. for 8 hours, the expected product is obtained.

### EXAMPLE 5

AMPS/AM/MA C₁₈ Ester (64/37/3) Copolymer Crosslinked with MBA

The following materials:

1000 g of tert-butanol,

6.75 g of octadecyl methacrylate,

100 g of commercial 2-methyl-2-[(1-oxo-2-propenyl)amino]-1-propanesulphonic acid (AMPS™),

8.2 g of ammonia,

127.52.2 g of acrylamide (AM),

0.5 g of methylenebis(acrylamide) (MBA), are successively charged to a reactor with stirring.

The mixture is subjected to sparging with nitrogen for approximately 1 hour at ambient temperature and then it is brought to 70° C., at which temperature 1.0 g of dilauryl peroxide is introduced therein. It is subsequently maintained at this temperature for approximately 2 hours and then it is left at reflux for two hours. After filtration and drying under reduced pressure at 60° C. for 8 hours, the expected terpolymer is obtained.

### EXAMPLE 6

AM/AMPS/MA C₁₈ Ester (52/45/3) Copolymer Crosslinked with MBA

The compound is obtained by carrying out the preparation in the same way as in Example 4 but using 6.75 g of octadecyl methacrylate, 70 g of 2-methyl-2-[(1-oxo-2-propenyl)amino]-1-propanesulphonic acid, 27.5 g of acrylamide and 5.75 g of aqueous ammonia.

### EXAMPLE 7

AMPS/AM/HEA/MA C₁₆ Ester (64/27/10/3) Copolymer Crosslinked with MBA

The compound is obtained by carrying out the preparation in the same way as in Example 4 but replacing the 17.2 g of acrylamide with 12.5 g of acrylamide and 7.65 g of hydroxyethyl acrylate (HEA).

### EXAMPLE 8

AMPS/MA C₁₂ Ester (97/3) Copolymer Cross-linked with TAOE

The compound is obtained by carrying out the preparation in the same way as in Example 1 but replacing octadecyl methacrylate with an equimolar amount of lauryl methacrylate (MA C₁₂ ester)

### EXAMPLE 9

AMPS/AA C16 Ester (97/3) Copolymer Cross-linked with TAOE

The compound is obtained by carrying out the preparation in the same way as in Example 1 but replacing octadecyl methacrylate with an equimolar amount of hexadecyl acrylate (AA C₁₆ ester).

### EXAMPLE 10

AMPS/MA C₈ Ester (97/3) Copolymer Cross-linked with TAOE

The compound is obtained by carrying out the preparation in the same way as in Example 1 but replacing octadecyl methacrylate with an equimolar amount of octyl methacrylate (MA C₈ ester)

### EXAMPLE 11

AMPS/MA C₃₀ Ester (88/12) Copolymer Cross-linked with TAOE

The compound is obtained by carrying out the preparation in the same way as in Example 4 but replacing octadecyl methacrylate with an equimolar amount of n-triacontyl methacrylate (MA C₃₀ ester) and adjusting the reaction temperature to 85° C.

### EXAMPLE 12

Noncrosslinked AMPS/AA C₂₂ Ester (97/3)

The compound is obtained by carrying out the preparation in the same way as in Example 1 but in the absence of tetraallyloxyethane, octadecyl methacrylate being replaced with an equimolar amount of docosyl acrylate (AA C₂₂ ester) and the reaction temperature being adjusted to 80° C.

1. Linear, branched or crosslinked polymer based on at least one monomer, possessing a free, partially salified or completely salified strong acid functional group, copolymerized with at least one monomer chosen either from esters of aliphatic alcohols comprising from 8 to 30 carbon atoms and of unsaturated monocarboxylic acids or from esters of aliphatic alcohols comprising from 8 to 30 carbon atoms and of unsaturated polycarboxylic acids.

2. Branched or crosslinked polymer as defined in claim 1, in which the crosslinking agent and/or the branching agent is chosen from diallyloxyacetic acid or one of the salts and in particular its sodium salt, trimethylolpropane triacrylate, ethylene glycol dimethacrylate, diethylene glycol diacrylate, tetraethylene glycol diacrylate, methylenebis(acryl-amide), diallylurea, triallylamine or 1,1,2,2-tetra-allyloxyethane.

3. Polymer as defined in either of claims 1 and 2, in which the strong acid functional group is partially or completely salified in the form of an alkali metal salt, such as the sodium salt or the potassium salt, of the ammonium salt (NH₄⁺) or of an aminoalcohol salt, such as, for example, the monoethanolamine salt (HOCH₂CH₂NH₃⁺).

4. Polymer as defined in one of claims 1 to 3, in which the strong acid functional group of the monomer comprising it is the sulphonic acid functional group or the phosphonic acid functional group.

5. Polymer as defined in one of claims 1 to 4, in which the monomer is chosen from styrenesulphonic acid, styrenephosphonic acid, (2-sulphoethyl) methacrylate or, preferably, 2-methyl-2-[(1-oxo-2-propenyl)aminol]-1-propanesulphonic acid, the said acids being free, partially salified or completely salified.

6. Polymer as defined in one of claims 1 to 5, in which the esters of aliphatic alcohols comprising from 8 to 30 carbon atoms and of unsaturated monocarboxylic or polycarboxylic acids are chosen from esters of α-unsaturated acids and more particularly of α-unsaturated monocarboxylic acids or α-unsaturated dicarboxylic acids.

7. Polymer as defined in claim 6, in which the esters of α-unsaturated monocarboxylic acids or of α-unsaturated dicarboxylic acids are chosen from esters of acrylic acid, methacrylic acid, itaconic acid or maleic acid.

8. Polymer as defined in one of claims 1 to 6, in which the aliphatic radical comprising from 8 to 30 carbon atoms of the ester functional group is a saturated or unsaturated and linear or branched radical.

9. Polymer as defined in claim 8, in which the aliphatic radical comprising from 8 to 30 carbon atoms of the ester functional group is chosen from radicals derived from linear primary alcohols and more particularly from the octyl, nonyl, decyl, undecyl, 10-undecenyl, dodecyl, tridecyl, tetradecyl, penta-decyl, hexadecyl, heptadecyl, octadecyl, 9-octadecenyl, 10,12-oct-decadienyl, nonadecyl, 13-docosenyl, docosyl or triacontyl radicals.

10. Polymer as defined in claim 8, in which the aliphatic radical comprising from 8 to 30 carbon atoms of the ester functional group is chosen from radicals derived from branched 1-alkanols corresponding to the general formula:
CH₃—(CH₂)ₚ—CH[CH₃—(CH₂)ₚ₋₂]—CH₂OH,
in which p represents an integer between 2 and 14, and more particularly from the 2-ethylhexyl, 2-propyl-heptyl, 2-butyloctyl, 2-pentylnonyl, 2-hexyldecyl or 2-octyldodecyl radicals.

11. Polymer as defined in claim 8, in which the aliphatic radical comprising from 8 to 30 carbon atoms of the ester functional group is chosen from the 2-hexyloctyl, 2-octyldecyl or 2-hexyldodecyl radicals or from radicals derived from isoalkanols corresponding to the general formula:
CH₃—CH (CH₃)—(CH₂)ₘCH₂OH,
in which m represents an integer between 2 and 26, and more particularly from the 4-methylpentyl, 5-methylhexyl, 6-methylheptyl, 15-methylpentadecyl or 16-methylheptadecyl radicals.

12. Polymer as defined in one of claims 1 to 11, characterized in that 30% to 98% of the monomer units which it comprises have a free, partially salified or completely salified strong acid functional group.

13. Polymer as defined in claim 12, characterized in that it comprises from 30% to 98% of at least one monomer having a strong acid functional group, from 1% to 15% of at least one ester with a fatty chain of an unsaturated carboxylic acid, from 0.01% to 5% of at least one polyethylenic monomer and from 0% to 60% by weight of at least one monomer chosen from neutral monomers or monomers with a free, partially salified or completely salified, nonesterified carboxylic acid functional group.

14. Polymer as defined in either of claims 12 and 13, characterized in that the neutral monomer is chosen from acrylamide, methacrylamide, vinylpyrrolidone, (2-hydroxyethyl) acrylate, (2-hydroxyethyl) methacrylate, (2,3-dihydroxypropyl) acrylate, (2,3-dihydroxypropyl) methacrylate or an ethoxylated derivative with a molecular weight of between 400 and 1000 of each of the hydroxylated esters described above and the monomer with a nonesterified carboxylic acid functional group is chosen from acrylic acid, methacrylic acid, itaconic acid or maleic acid.

15. Process for the preparation of the polymer as defined in one of claims 1 to 14, characterized in that
a) all the monomers are dissolved in a solvent,
b) the polymerization reaction is initiated by the introduction, into the solution formed in a), of a free radical initiator and then the reaction is allowed to take place,
c) when the polymerization reaction is finished, filtration and drying are carried out.

16. Use of the polymer as defined in one of claims 1 to 14 for preparing a cosmetic, dermocosmetic, dermopharmaceutical or pharmaceutical topical composition.

17. Cosmetic, dermocosmetic, dermopharmaceutical or pharmaceutical topical composition, characterized in that it comprises from 0.1% to 10% by weight of the polymer as defined in one of claims 1 to 14.

18. Use of the polymer as defined in one of claims 1 to 14 for thickening and/or emulsifying inks, paints or compositions for dyeing natural or synthetic textile fibres, or dyeing or pigmentary compositions for woven or nonwoven products.
